(19) United States
(12) Patent Application Publication
(10) Pub. No.: US 2009/0115929 A1
(43) Pub. Date: May 7, 2009

(54) BACKLIGHT UNIT, LIQUID CRYSTAL DISPLAY APPARATUS HAVING THE SAME, AND METHOD THEREOF

(75) Inventors: Ki-Hwan BAEK, Asan-si (KR); Jae-Hwan CHUN, Suwon-si (KR); Jong-Ho WON, Suwon-si (KR); Hyun-Su PARK, Suwon-si (KR); Jae-Sang LEE, Cheonan-si (KR)

Correspondence Address: CANTOR COLBURN, LLP, 20 Church Street, 22nd Floor, Hartford, CT, 06103, US

(73) Assignee: Samsung Electronics Co., Ltd., Suwon-si (KR)

(21) Appl. No.: 12/259,524

(22) Filed: Oct. 28, 2008

(30) Foreign Application Priority Data
Oct. 31, 2007 (KR) 1020070110335

(51) Int. Cl. G02F 1/13357; G02F 1/1333; H01J 9/00

(52) U.S. Cl. 349/58; 362/97.2; 445/23

(57) ABSTRACT

A backlight unit includes planar light source and light source socket. The planar light source includes upper and lower plates combined with each other and forming a light emitting space therebetween, and external electrodes disposed on surface of one of the upper and lower plates. The light source socket is disposed on a portion of the external electrodes. The light source socket includes a body, a power applying member and a fixing member. The body covers the portion of the external electrode. The power applying member is disposed inside of the body and contacts the external electrode in order to apply electric power to the planar light source. The fixing member fastens the power applying member to the external electrode such that the power applying member makes contact with the external electrode.

The present application claims priority to Korean Patent Application No. 10-2007-110335, filed on Oct. 31, 2007, and all the benefits accruing therefrom under 35 U.S.C. §119, the contents of which is incorporated herein by reference in its entirety.

### BACKGROUND OF THE INVENTION

1. Field of the Invention

The present invention relates to a backlight unit and a liquid crystal display (“LCD”) apparatus including the backlight unit. More particularly, the present invention relates to a backlight unit improving a voltage source connection structure, and an LCD apparatus including the backlight unit.

2. Description of the Related Art

Various electronic devices such as a cellular phone, a digital camera, a notebook computer, a monitor, etc., include a display apparatus. Various display apparatuses may be employed, but a flat panel display (“FPD”) apparatus is normally used.

An LCD apparatus, which is a representative FPD apparatus, displays images by using electric and optical characteristics of liquid crystal. The LCD apparatus has many merits such as thin thickness, lightweight, low power consumption, low driving voltage, etc. Therefore, the LCD apparatus is used in various display industries.

The LCD apparatus includes a LCD panel displaying images, a driving circuit part driving the LCD panel, and a backlight unit providing the LCD panel with light. The LCD apparatus having a large screen size employs a direct illumination type backlight unit in which a plurality of lamps are disposed substantially in parallel with each other, and under the LCD panel to provide the LCD panel with light.

A planar light source has been used as the direct illumination type backlight unit in order to enhance light-using efficiency. A conventional direct illumination type backlight unit employs a planar light source having an external electrode with a wire-pressing and soldering structure for being electrically connected to an external voltage source. In order to manufacture the conventional direct illumination type backlight unit, a soldering process and automated equipment for the soldering process are required.

### BRIEF SUMMARY OF THE INVENTION

Since a direct illumination type backlight unit employs a planar light source having an external electrode, there are difficulties in manufacturing the backlight unit with a wire-pressing and soldering structure for being electrically connected to an external voltage source. For example, a soldering process and automated equipment for the soldering process are required for the manufacturing of the backlight unit, which undesirably enhances a manufacturing cost thereof. Furthermore, in the soldering process, micro cracks may be formed due to high temperature, and terminals may not be perfectly connected with each other by the solder, which disadvantageously deteriorates a quality of the backlight unit.

Exemplary embodiments of the present invention provide a backlight unit having a voltage source connection structure capable of reducing a manufacturing cost thereof and enhancing a light source quality by eliminating the soldering process.

Exemplary embodiments of the present invention also provide an LCD apparatus having the backlight unit.

In an exemplary embodiment, a backlight unit includes a planar light source and a light source socket. The planar light source includes upper and lower substrates combined with each other to form light emitting space therebetween, and external electrodes disposed on a surface of at least one of the upper and lower substrates. The light source socket is disposed at a portion of the external electrode. The light source socket includes a body, a power applying member and a fixing member. The body covers the portion of the external electrode. The power applying member is formed inside of the body and contacts the external electrode in order to apply electric power to the planar light source. The fixing member fastens the power applying member to the external electrode, so that the power applying member makes contact with the external electrode.

In an exemplary embodiment, the body may include a combination portion into which the fixing member is inserted, and the fixing member is fixed to the body when inserted into the combination portion.

In an exemplary embodiment, the fixing member may include a catching jaw formed on a first surface of the fixing member. The catching jaw makes contact with the combination portion when the fixing member is inserted into the combination portion such that separation of the fixing member from the combination portion is restricted. The fixing member may further include a rib protruding from a second surface of the fixing member facing the power applying member. The rib compresses the power applying member when the fixing member is inserted into the combination portion such that the power applying member is electrically connected to the external electrode.

In an exemplary embodiment, a first end portion of the power applying member contacts the external electrode, and may be rounded.

In an exemplary embodiment, the body may include a power connection portion connected to a power supply.

In an exemplary embodiment, the backlight unit may further include a connector being electrically connected to the power connection portion. The connector may be disposed between the power connection portion and the power supply.

In an exemplary embodiment, the connector may be connected to an end portion of a power supplying wire extended from the power supply. Additionally, the power applying member may be electrically connected to the connector through the power connection portion.

In an exemplary embodiment, the light source socket is removably disposed on the external electrode.

In an exemplary embodiment, an LCD apparatus includes an LCD panel, a driving circuit part and a backlight unit. The LCD panel displays images. The driving circuit part drives the LCD panel. The backlight unit includes a planar light source and a light source socket. The planar light source includes upper and lower substrates combined with each other to form light emitting space therebetween, and external electrodes disposed on a surface of at least one of the upper and lower substrates. The light source socket is disposed at a portion of the external electrode.

The light source socket includes a body, a power applying member and a fixing member. The body covers a portion of the external electrode. The power applying member is disposed at an inner surface of the body and contacting with the external electrode in order to apply electric power to the planar light source. The fixing member fastens the power applying member to the external electrode, such that the power applying member makes contact with the external electrode to apply the electric power to the planar light source.

In an exemplary embodiment, the LCD apparatus may further include a bottom chassis receiving the backlight unit.

In an exemplary embodiment, the light source socket includes a power connection portion electrically connected to a power supply. The power connection portion may be disposed between the body and the power supply.

In an exemplary embodiment, the bottom chassis may include a light source socket fixing member into which the power connection portion is inserted. The power connection portion is fixed to the bottom chassis when inserted into the light source fixing member.

In an exemplary embodiment, the power connection portion may be electrically connected to a connector formed at an end portion of a power supplying wire for transferring electric power. Additionally, a first end portion of the power applying member, which may be rounded, is electrically connected to the external electrode. A second end portion of the power applying member, which is opposite to the first end portion, may be electrically connected to the connector through the power connection portion.

In an exemplary embodiment, the light source socket may cover a portion of an upper surface of the light source, and a portion of a lower surface of the light source. The power applying member is continuously disposed from the first end portion disposed at the upper surface of the light source to the second end portion disposed at the lower surface of the light source.

In an exemplary embodiment, the body may include a combination portion into which the fixing member is inserted, the inserted fixing member being fixed to the body. The fixing member may include a catching jaw and a rib restricting separation from the combination portion. The catching jaw may be formed on a first surface and contacts the combination portion to restrict separation of the fixing member from the combination portion. The rib may protrude from a second surface facing the power applying member, and compress the power applying member to be electrically connected to the external electrode.

An exemplary embodiment provides a method of forming a backlight unit. The method includes forming a planar light source including a plurality of external electrodes disposed on an outer surface of at least one of an upper substrate and a lower substrate of the planar light source, and removably combining a pair of a light source sockets on a portion of the external electrodes of the planar light source.

Each of the light source sockets includes a body facing a plurality of outer surfaces of the planar light source and a power applying member. The body includes a fixing member disposed between the body and the planar light source. The power applying member is disposed on an inner surface of the body, and disposed adjacent to and contacting the plurality of outer surfaces of the planar light source. The fixing member maintains the power applying member in contact with the external electrode, and the light source socket is removably combined with the planar light source solely by the body of the light source socket.

An exemplary embodiment of the LCD apparatus includes socket for providing electric power to the light source. Therefore, a manufacturing cost thereof may be reduced and the manufacturing process thereof may be simplified by eliminating the soldering process.

An exemplary embodiment of the LCD apparatus protects the light source from heat and compression which were applied to the light source through the conventional soldering process by using the socket. Therefore, the LCD apparatus reduces progressive malfunctions to enhance display quality.

An exemplary embodiment provides the socket may be easily connected to and separated from the backlight unit, when the socket is out of order.

### BRIEF DESCRIPTION OF THE DRAWINGS

Exemplary embodiments of the present invention can be understood in more detail from the following descriptions taken in conjunction with the accompanying drawings, in which:

FIG. 1 is an exploded perspective view illustrating an exemplary embodiment of an LCD apparatus according to the present invention;

FIG. 2 is an exploded perspective view illustrating an exemplary embodiment of an LCD panel in FIG. 1;

FIG. 3 is a perspective partial view illustrating an exemplary embodiment of a light source socket in FIG. 1;

FIG. 4 is a perspective partial view illustrating an exemplary embodiment of a light source socket in FIG. 1; and

FIGS. 5A and 5B are cross-sectional perspective views illustrating an exemplary embodiment of a light source socket in FIG. 1.

### DETAILED DESCRIPTION OF THE INVENTION

Detail operations and exemplary embodiments of the invention are described more fully hereinafter with reference with the accompanying drawings. The present invention may, however, be embodied in many different forms and should not be construed as limited to the exemplary embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on” or “connected to” another element or layer, the element or layer can be directly on or connected to another element or layer or intervening elements or layers. In contrast, when an element is referred to as being “directly on” or “directly connected to” another element or layer, there are no intervening elements or layers present. Like numbers refer to like elements throughout. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, the present invention will be described in detail with reference to the accompanying drawings

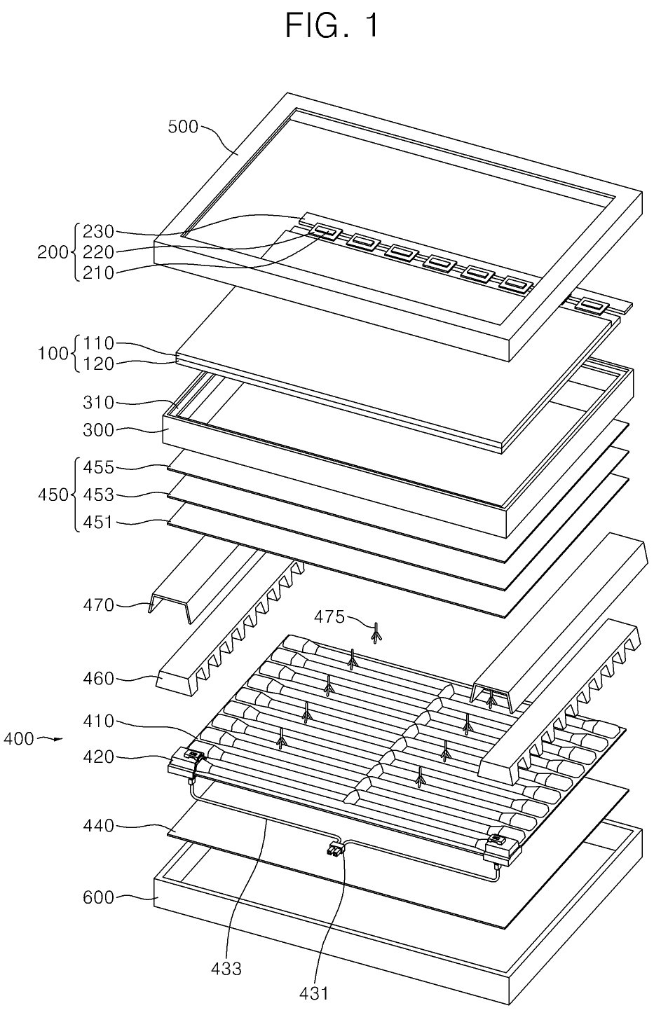

FIG. 1 is an exploded perspective view illustrating an exemplary embodiment of an LCD apparatus according to the present invention.

Referring to FIG. 1, an LCD apparatus according to the exemplary embodiment, includes an LCD panel 100, a panel driving part 200, a mold frame 300, a backlight unit 400, a top chassis 500 and a bottom chassis 600.

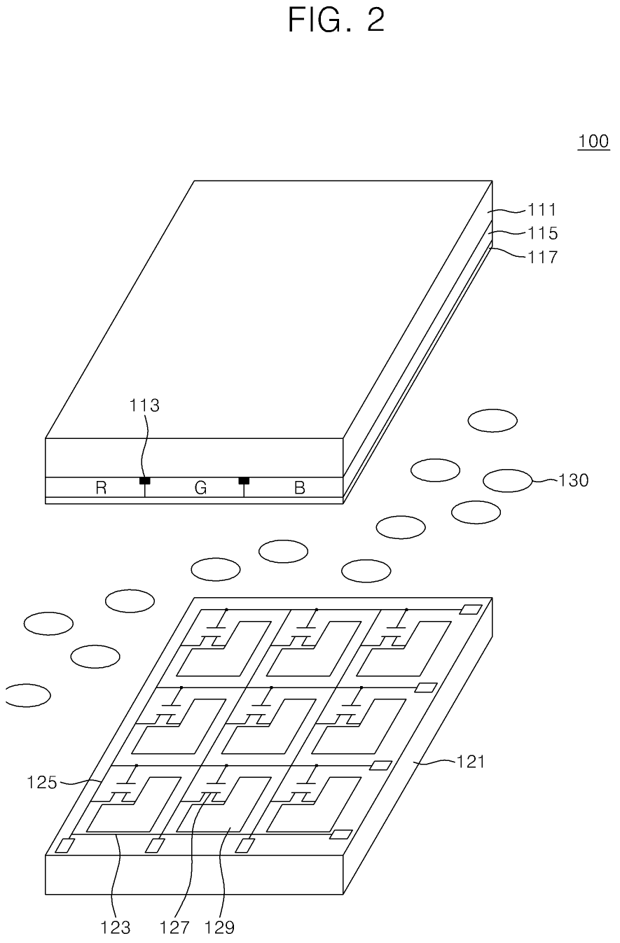

The LCD panel 100 includes a color filter substrate 110, a thin film transistor (“TFT”) substrate 120 combined with the color filter substrate 110, and liquid crystal 130 (refer to FIG. 2) disposed between the color filter substrate 110 and the TFT substrate 120 to control light transmittance. The LCD panel 100 will be explained in more in detail referring to FIG. 2.

FIG. 2 is an exploded perspective view illustrating an exemplary embodiment of an LCD panel in FIG. 1.

Referring to FIGS. 1 and 2, the color filter substrate 110 includes an upper substrate 111, a black matrix 113, a color filter layer 115 and a common electrode 117. The upper substrate 111 may include an optically transparent dielectric material, such as glass, plastic, etc. The black matrix 113 is disposed on the upper substrate 111 to block light leakage, such as on a lower surface of the upper substrate 111 which faces the common electrode 117. The color filter 115 is configured to reproduces colors. The common electrode 117 generates electric fields together with a pixel electrode of the TFT substrate 120.

The TFT substrate 120 includes a lower substrate 121, gate lines 123, data lines 125, TFTs 127, and pixel electrodes 129. The lower substrate 121 may include optically transparent dielectric material, such as glass, plastic, etc. The gate lines 123 and the data lines 125 are disposed on the lower substrate 121 and are arranged crossing each other. In an exemplary embodiment, the gate lines 123 may be extended in a transverse direction of the LCD panel 100 and may be arranged along a longitudinal direction of the LCD panel 100. Conversely, the data lines 125 may be extended in the longitudinal direction of the LCD panel 100, and arranged along the transverse direction of the LCD panel. One or more of the TFTs 127 may be formed at a region where the gate lines 123 and the data lines 125 cross with each other. Each of the pixel electrodes 129 is electrically connected to one of the TFTs 127.

Liquid crystal molecules of the liquid crystal 130 are arranged along a specific direction by alignment layers (not shown) of the color filter substrate 110 and the TFT substrate 120. When electric fields are generated between the pixel electrode 129 and the common electrode 117, the liquid crystal molecules are rearranged to control light transmittance.

Referring again to FIG. 1, the panel driving part 200 is electrically connected to one side of the TFT substrate 120 to provide the gate and data lines 123 and 125 of the LCD panel 100 with driving signals. In an exemplary embodiment, the panel driving part 200 may be formed at a longitudinal edge of the TFT substrate 120. The panel driving part 200 includes a gate driver (not shown) for driving the gate lines 123 and a data driver 210 for driving the data lines 125.

In an exemplary embodiment, the gate driver may be formed as a chip mounted on the TFT substrate 120 such as a chip on glass (“COG”), or the gate driver may be formed directly on the TFT substrate 120. Alternatively, the gate driver may be formed as a chip mounted on a tape carrier package (“TCP”) and electrically connected to the LCD panel 100 through a TCP bonding process. As illustrated in the exemplary embodiment of FIG. 2, the gate driver may be, for example, directly formed on the TFT substrate 120, and the data driver 210 may be formed as a chip mounted on a TCP 220.

The data driver 210 is mounted on the TCP 220 and is electrically connected to a printed circuit board (“PCB”) 230 connected on one side of the TCP 220. The PCB 230 may include, a timing control section, a power source and/or various circuit devices mounted thereon. The PCB 230 provides the gate driver and the data driver 210 with power, image data and/or various control signals provided from an external apparatus.

The mold frame 300 receives the LCD panel 100 and protects the LCD panel 100 from external impact. The mold frame 300 may include, for example, plastic, and/or may have a receiving portion 310 for receiving the LCD panel 100. The receiving portion 310 may include any of a number of members such as a bottom surface, side surfaces, sidewalls, stepped portions, etc., such as to provide a receiving space for the LCD panel 100.

The backlight unit 400 is disposed under (e.g., opposing a viewing side) the LCD panel 100 to provide the LCD panel 100 with light. The backlight unit 400 includes a light source 410, a light source socket 420, a reflection sheet 440 and optical sheets 450.

The light source 410 generates light applied to the LCD panel 100. In an exemplary embodiment, the light source 410 may include a planar light source. The planar light source may include upper and lower substrates combined with each other, and a light emitting space disposed between the upper and lower substrates. External electrodes 411 (refer to FIG. 3) may be formed on a surface of at least one of the upper and lower substrates of the planar light source. Gases including, but not limited to, mercury (Hg) gas, argon (Ar) gas, and neon (Ne) gas, may be injected into the light emitting space between the upper and lower substrates The upper and lower substrates are sealed to form the light emitting space therebetween. The light source 410 provides the LCD panel 100 with planar light.

In an alternative embodiment, the light source 410 may employ a plurality of light emitting diodes (“LEDs”) disposed under the LCD panel 100 and arranged substantially in parallel with each other, or in a matrix shape, to form the direct illumination type backlight unit.

The light source socket 420 provides the light source 410 with power. In the exemplary embodiment of FIG. 1, the power may be provided through a first connector 431 and a power supplying wire 433. As illustrated in FIG. 1, a light source socket 420 may be disposed at opposing ends of the light source. While a single pair of light source sockets 420 are shown in the exemplary embodiment, more than one pair of the light source sockets 420 may be employed in the backlight unit 400. The light source socket 420 will be explained in more detail.

The reflection sheet 440 is disposed under the light source 410. The reflection sheet 440 may be formed in a substantially plate shape and have a relatively high light-reflectivity. The reflection sheet 440 reflects light initially advancing in a lower (e.g., downward) direction from the light source 410 toward the LCD panel 100 to reduce light leakage and enhance light-using efficiency. In an exemplary embodiment, a material having high reflectivity may be coated on a base material to form the reflection sheet 440.

The optical sheets 450 may include, but are not limited to, a diffusion sheet 451, a prism sheet 453, a protection sheet 455, etc. The diffusion sheet 451 diffuses light generated by the light source 410 and provides the LCD panel 100 with light of which luminance is substantially uniform. In an exemplary embodiment, a diffusion plate having a substantially plate-shape may replace the diffusion sheet 451. The prism sheet 453 condenses light by controlling light-advancing direction to be substantially perpendicular to the LCD panel 100, to enhance front-view luminance of the LCD apparatus. The protection sheet 455 prevents damage (for example, a scratch) to the prism sheet 453 and protects the prism sheet 453. As illustrated in the embodiment of FIG. 1, the optical sheets 450 may be supported by a supporter 475 disposed on the light source 410, and/or a side mold 470 that will be described below.

The backlight unit 400 further includes a thermal member (e.g., a pad) 460 and the side mold 470. The thermal pad 460 is disposed over an external electrode 411 (refer to FIG. 3) to dissipate heats generated by the external electrode 411. A thermal pad 460 may be disposed at each of opposing ends of the light source 410. The side mold 470 is disposed at each of end portions of the light source 410 and covers the thermal pad 460. The side mold 470 covers the external electrodes 411 and the thermal pad 460. In an exemplary embodiment, lower portions of the side mold 470 may be formed to have a concavo-convex shape along the surface of the light source 410, such as to correspond to a profile of an upper surface of the light source 410. In exemplary embodiments, the side mold 470 may have a specific height, such as to accommodate the external electrodes 411 and the thermal pad 460 and. The side mold 470 also supports the optical sheets 450, such as on an upper surface of the side mold 470. Alternatively, the side mold 470 may have a stepped portion to support the optical sheets 450. In detail, the side mold 470 supports the optical sheets 450, so that the optical sheets 450 are spaced apart from the light source 410.

The top chassis 500 is disposed over the LCD panel 100 to protect the LCD panel 100 and the backlight unit 400 from an external impact. The top chassis 500 is substantially frame-shaped and includes an opening for exposing a display region of the LCD panel 100. The top chassis 500 surrounds outer edge portions of the LCD panel 100.

The bottom chassis 600 receives the LCD panel 100 and the backlight unit 400, and is combined with the top chassis 500 to protect the LCD panel 100 and the backlight unit 400.

Hereinafter, an exemplary embodiment of the light source socket according to the present invention will be explained in more detail referring to FIGS. 3, 4, 5A and 5B.

FIGS. 3, 4, 5A and 5B are perspective views illustrating exemplary embodiments of a light source socket in FIG. 1.

Referring to FIGS. 3, 4, 5A and 5B, the light source socket 420 includes a body 421, a power applying member 425 and a fixing member 427.

The body 421 is disposed such that the body 421 covers a portion of the external electrode 411 as shown in FIG. 3, such as covering a distal end of the external electrode 411. The body 421 may be formed separately from the light source 410, and subsequently combined with the light source 410 to overlap the portion of the external electrode 411. The body 421 may be removably attached to the light source 410.

As illustrated in the exemplary embodiment of FIGS. 1 and 3, two adjacent sides of the body 421 may include an opening such that the body 421 may be separably combined with a corner portion of the light source 410. The body 421 of the light source socket 420 may be combined with the light source 410 in a sliding assembly. Alternatively, the light source socket 420 may be disposed between two corners of the light source 410, such as at a transverse or longitudinal edge of the light source 410. In exemplary embodiments, the light source socket 420 may be disposed at any of a number of positions along the light source 410 such that the light source socket 420 may be removably disposed on the light source.

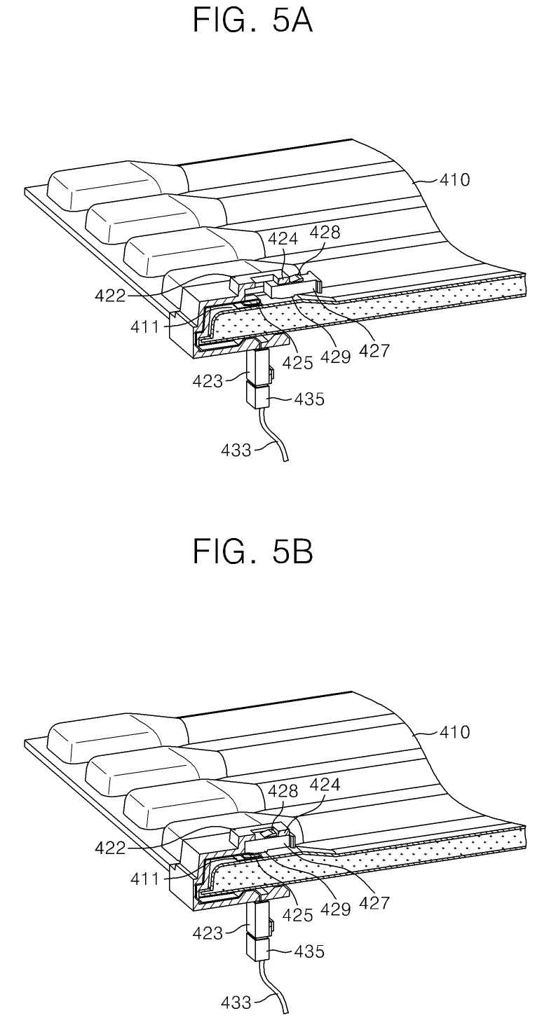

The body 421 may include a dielectric material such that the body 421 is electrically insulated from other conductive materials of the LCD apparatus. Referring to FIGS. 3, 5A and 5B, a combination portion 422 may be formed at an upper portion of the body 421, and a power connection portion 423 is formed at a lower portion of the body 421.

The combination portion 422 upwardly protrudes from the body 421, and is configured so that the fixing member 427 may be inserted into the combination portion 422. In an exemplary embodiment, an upper portion of the combination portion 422 may be opened, so that the fixing member 427 may be seen or checked during or after the inserting.

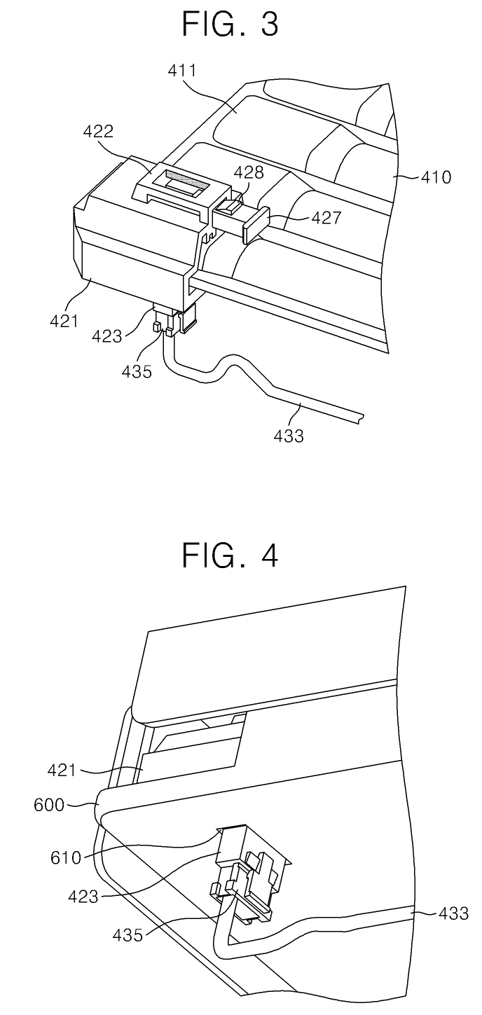

The power connection portion 423 downwardly protrudes from the body 421 as shown in FIG. 4, and penetrates a light source socket fixing member 610 disposed in the bottom chassis 600. The light source socket fixing member 610 may be formed as a hole (e.g., penetrating completely or partially through a lower surface of the bottom chassis 600). In an exemplary embodiment, when the power connecting portion 423 is disposed in the light source socket fixing member 610, a distal end of the power connecting portion may be exposed from the bottom chassis 600.

The light source socket fixing member 610 may also be combined with a second connector 435 of the light source socket 420. The second connector 435 is formed at an end portion of the power supplying wire 433 extended from an external power supply (not shown). The light source socket fixing member 610 may be configured slightly larger than the power connection portion 423, such as to accommodate a dimension of the power connection portion 423 and reduce, or effectively prevent, undesirable movement of the power connection portion 423. Advantageously, the light source socket fixing member 610 reduces or effectively prevents floating of the power connection portion 423, so that separation of the body 421 from the light source 410 is reduced or effectively prevented. Additionally, the light source socket fixing member 610 reduced or effectively prevents malconnection between the power applying member 425 in the body 421, and the external electrode 411 of the light source 410.

The power applying member 425 is formed inside of the body 421 as shown in FIGS. 5A and 5B. A portion of the power applying member 425 may be buried or inserted in the body 421, such that the power applying member 425 is fixed to the body 421. In an exemplary embodiment, the power applying member 425 may include an elastic and/or electrically conductive material. The power applying member 425 is formed along an internal surface of the body 421, such as at a surface facing the light source 410.

As illustrated in FIGS. 5A and 5B, a first end portion of the power applying member 425 is disposed at the combination portion 422, and a second end portion of the power applying member 425 is disposed at the power combination portion 423. The first end portion of the power applying member 425 is configured to have a shape for making contact with the external electrode 411 (e.g., an upper surface) of the light source 410. In an exemplary embodiment, the first end portion of the power applying member 425 is downwardly curved to have a convex shape and makes contact with the external electrode 411. The power applying member 425 may make surface-contact with the external electrode 411 of the light source 410, so that electric power may be effectively transferred to the light source 411.

The second end portion of the power applying member 425 is disposed at the power combination portion 423 and is electrically connected to the second connector 435, which is electrically connected to the power supplying wire 433. The power applying member 425 may also contact a portion of the external electrode 411 disposed at the lower portions of the light source 410, such as where the portion of the external electrode 411 is disposed on a rear of the lower substrate of the light source 410. When the power applying member 425 additionally contact a portion of the external electrode 411 at a rear of the light source, the light source 410 is stably provided with electric power.

For the power applying member 425 to contact the upper and lower surfaces of the external electrode 411 of the light source 420 the power applying member 425 is a single continuous member from a first distal end to a second distal end. The power applying member 425 may have a curved or direction-changing shape which is disposed along an inner surface contour of the body 421. The power applying member 425 may be considered continuously and completely disposed between the body 421 of the light source socket 420 and the light source 410, such as along a profile of an outer surface of the light source 410.

The fixing member 427 may have a substantial rectangular parallel piped shape, such as for being inserted into the combination portion 422 of the body 421 as shown in FIG. 5A. In an exemplary embodiment, the fixing member 427 may include, but is not limited to, a dielectric material. The fixing member 427 may include a same dielectric material as the body 421.

Referring to FIGS. 3, 5A and 5B, the fixing member 427 includes a catching jaw 428 formed on an upper surface of the fixing member 427. The catching jaw 428 contacts the combination portion 422, such as in an interference fit. The catching jaw 428 guides and controls a horizontal sliding of the fixing member 427, such that the fixing member 427 is fixed to the body 421 when the fixing member 427 is inserted into the combination portion 422. As illustrated in FIGS. 5A and 5B, the fixing member 427 may be slid in a combination direction from right to left.

The catching jaw 428 of the fixing member 427 is formed at a region of the fixing member 427 corresponding to a catching jaw supporting portion 424 of the combination portion 422. The catching jaw 428 is formed at a specific region such that the fixing member 427 is fixed to the body 421 when the fixing member 427 is inserted into the combination portion 422. A combination of the catching jaw 428 and the combination portion 422 may result in the fixing member 427 being fixed to the combination portion 422 solely by the combination of the catching jaw 428 and the combination portion 422.

The catching jaw 428 protrudes (e.g., substantially perpendicular) from the upper surface of the fixing member 427). The catching jaw 428 is protruded in an upward, or vertical, direction and extends a specific length (or height). The height of the catching jaw 428 is of a sufficient distance so that the catching jaw 428 is supported by the catching jaw supporting portion 424 when the fixing member 427 is completely inserted into the combination portion 422. The height of the catching jaw 428 is determined by considering a space between the external electrode 411 of the light source 410 and the catching jaw supporting portion 424. A height of the catching jaw 428 is substantially equal to or slightly greater than the space between the external electrode 411 of the light source 410 and the catching jaw supporting portion 424, so that the fixing member 427 may be easily inserted into the combination portion 422.

As shown in the exemplary embodiments of FIGS. 3, 5A and 5B a first side (e.g., distal end) of the catching jaw 428 may be inclined in order that the fixing member 427 is relatively easily inserted into the combination portion 422. A second side of the catching jaw 428, which is opposite to the first side, may be substantially vertically formed in order that the catching jaw 428 of the fixing member 427 is supported by the catching jaw supporting portion 424.

When the catching jaw 428 is fully inserted into the combination portion 422, and is disposed in the opened area of the combination portion 422, the vertical second side of the catching jaw 428 may contact an inner surface of an inner side of the catching jaw supporting portion 424. An interference of the height of the catching jaw 428 and a thickness of the combination portion 422 maintains the fixing member 427 and the combination portion 422 in an assembled state, and reduces or effectively prevents the fixing member 427 from moving in a direction opposite to the combination direction. In an exemplary embodiment, when the catching jaw 428 is fully inserted into the combination portion 422, a lower surface of the catching jaw supporting portion 424 may contact the upper surface of the fixing member 427.

As shown in the exemplary embodiments of FIGS. 5A and 5B, the fixing member 427 may further include a rib 429 formed at a surface of the fixing member 427, which faces the power applying member 425. For example, the rib 429 may protrude from a lower surface of the fixing member 427, such that the rib 429 makes contact with the power supplying member 425 when the fixing member 427 is inserted into the combination portion 422 of the light source socket 420. A distal end (e.g., lowermost end) of the rib 429 may have a substantially rounded shape in order that the fixing member 427 slides along the upper surface of the light source and is relatively easily inserted into the combination portion 422.

When the fixing member 427 including the rib 429 is inserted into the combination portion 422, the rib 429 compresses the first end portion of the power applying member 425, which is rounded, and allows the fixing member 427 to be inserted into the combination portion 422. When the rib 429 of the fixing member 427 compresses the first end portion of the power applying member 425 towards the light source 411, the power applying member 425 makes contact with the external electrode 411. As the fixing member 427 is fully inserted into the combination portion 422, the rib 429 may remain in contact with the power applying member 425, and maintain the first end of the power applying member 425 in a partially or completely compressed state. With the fixing member 427 inserted into the combination portion 422, the light source socket 420 provides electric power provided from an external power supply (not shown) to the light source 410.

The fixing member 427 may be separated from the combination portion 422 by compressing the fixing member 427 through the opening formed at the combination portion 422, and then pushing the fixing member 427 along a direction that is opposite to the combination direction. As the fixing member 427 is fully retracted from the combination portion 422, the rib 429 may be separated from the first end portion of the power applying member 425, and the first end portion of the power applying member 425 may become uncompressed and eventually return to an uncompressed state. As a result, the light source socket 420 is detachably disposed with the light source 410, and may be separated from the light source 410. Advantageously, when the light source socket 420 is out of order, the light source socket 420 may be replaced by a new one.

In the exemplary embodiments, the light source socket 420 assembled with the light source 410 is disposed on and contacts at least both the opposing upper and the lower outer surfaces of the light source 410. When the fixing member 427 is combined with the combination portion 422, the light source socket 420 is assembled with the light source 410. The combination jaw 428, the rib 429 and/or a thickness (e.g., in a vertical direction) of the fixing member 427 collectively and substantially occupy the space between the external electrode 411 of the light source 410 and the catching jaw supporting portion 424, such that the light source socket 420 is held fixed to the light source 410. A combination of the fixing member 427 and the combination portion 422 solely fixes the light source socket 420 to the light source 410. Advantageously, no separate attachment means is required to fix the light source socket 420 to the light source 410. Furthermore, a combination of the fixing member 427 and the combination portion 422 as shown in the exemplary embodiments provides a detachable disposition of the light source socket 420 to the light source 410.

While the exemplary embodiments of the present invention and their advantages have been described in detail, it should be understood that various changes, substitutions and alterations may be made herein without departing from the scope of the invention.

Therefore, a technical range of the present invention should by limited by the claims, not by the specification.

What is claimed is:

1. A backlight unit comprising:
a planar light source including upper and lower substrates combined with each other and forming a light emitting space therebetween, and external electrodes disposed on a surface of at least one of the upper and lower substrates; and
a light source socket disposed on a portion of the external electrode, the light source socket comprising:
a body covering the portion of the external electrode;
a power applying member disposed inside of the body and contacting the external electrode in order to apply electric power to the planar light source; and
a fixing member fixing the power applying member to the external electrode such that the power applying member contacts the external electrode.

2. The backlight unit of claim 1, wherein the body comprises a combination portion into which the fixing member is inserted, and the fixing member is fixed to the body when inserted into the combination portion.

3. The backlight unit of claim 2, wherein the fixing member comprises a catching jaw formed on a first surface of the fixing member, the catching jaw contacting the combination portion when the fixing member is inserted into the combination portion such that separation of the fixing member from the combination portion is restricted.

4. The backlight unit of claim 3, wherein the fixing member further comprises a rib protruding from a second surface of the fixing member facing the power applying member, the rib compressing the power applying member when the fixing member is inserted into the combination portion such that the power applying member is electrically connected to the external electrode.

5. The backlight unit of claim 1, wherein a first end portion of the power applying member contacts the external electrode and is rounded.

6. The backlight unit of claim 1, wherein the body comprises a power connection portion electrically connected to a power supply.

7. The backlight unit of claim 6, further comprising a connector being connected to the power connection portion, and disposed between the power connection portion and the power supply.

8. The backlight unit of claim 7, wherein the connector is connected to an end portion of a power supplying wire extended from the power supply.

9. The backlight unit of claim 8, wherein the power applying member is electrically connected to the connector through the power connection portion.

10. The backlight unit of claim 1, wherein the light source socket is removably disposed on the external electrode.

11. A liquid crystal display apparatus comprising:
a liquid crystal display panel displaying images;
a driving circuit part driving the liquid crystal display panel; and
a backlight unit including:
a planar light source including upper and lower substrates combined with each other and forming a light emitting space therebetween, and external electrodes disposed on a surface of at least one of the upper and lower substrates; and
a light source socket disposed at a portion of the external electrode, the light source socket including:
a body covering a portion of the external electrode;
a power applying member disposed at an inner surface of the body and contacting the external electrode in order to apply electric power to the planar light source; and
a fixing member fixing the power applying member to the external electrode such that the power applying member contacts the external electrode to apply the electric power to the planar light source.

12. The liquid crystal display apparatus of claim 11, further comprising a bottom chassis receiving the backlight unit.

13. The liquid crystal display apparatus of claim 12, wherein the light source socket comprises a power connection portion electrically connected to a power supply, and disposed between the body and the power supply.

14. The liquid crystal display apparatus of claim 13, wherein the bottom chassis comprises a light source socket fixing member into which the power connection portion is inserted, such that the power connection portion is fixed to the bottom chassis when inserted into the light source socket fixing member.

15. The liquid crystal display apparatus of claim 13, wherein the power connection portion is electrically connected to a connector disposed at an end portion of a power supplying wire, the power connection portion transferring electric power to the light source.

16. The liquid crystal display apparatus of claim 15, wherein a first end portion of the power applying member is electrically connected to the external electrode, and a second end portion of the power applying member, which is opposite to the first end portion, is electrically connected to the connector through the power connection portion.

17. The liquid crystal display apparatus of claim 16, wherein the light source socket covers a portion of an upper surface of the light source, and covers a portion of a lower surface of the light source, and
wherein the power applying member is continuously disposed from the first end portion disposed at the upper surface of the light source to the second end portion disposed at the lower surface of the light source.

18. The liquid crystal display apparatus of claim 11, wherein the body comprises a combination portion into which the fixing member is inserted, and the inserted fixing member is fixed to the body.

19. The liquid crystal display apparatus of claim 18, wherein the fixing member comprises:
a catching jaw formed on a first surface of the fixing member, the catching jaw contacting the combination portion and restricting separation of the fixing member from the combination portion; and
a rib protruding from a second surface of the fixing member facing the power applying member, the rib compressing the power applying member such that the power supplying member is electrically connected to the external electrode.

20. A method of forming a backlight unit, the method comprising:
forming a planar light source including a plurality of external electrodes disposed on an outer surface of at least one of an upper substrate and a lower substrate of the planar light source;
removably combining a pair of a light source sockets on a portion of the external electrodes of the planar light source, each of the light source sockets including:
a body facing a plurality of outer surfaces of the planar light source, and including a fixing member disposed between the body and the planar light source;
a power applying member disposed on an inner surface of the body, and disposed adjacent to and contacting the plurality of outer surfaces of the planar light source;
wherein the fixing member maintains the power applying member in contact with the external electrode, and the light source socket is removably combined with the planar light source solely by the body of the light source socket.
